(19) United States
(12) Patent Application Publication
(10) Pub. No.: US 2022/0092444 A1
(43) Pub. Date: Mar. 24, 2022

(54) SYSTEM AND METHOD FOR EXPLAINING ACTIONS TAKEN IN REAL-TIME ON EVENT STREAM USING NLG

(71) Applicants: VIVEK MISHRA, Lucknow (IN); ROMIL SHAH, Mumbai (IN); DHWANIL SHAH, Mumbai (IN)

(72) Inventors: VIVEK MISHRA, Lucknow (IN); ROMIL SHAH, Mumbai (IN); DHWANIL SHAH, Mumbai (IN)

(21) Appl. No.: 17/146,487

(22) Filed: Jan. 11, 2021

(30) Foreign Application Priority Data
Sep. 21, 2020 (IN) 202021040826

(51) Int. Cl. G06N 5/02; G06F 40/56; G06F 9/451

(52) U.S. Cl. CPC G06N 5/025; G06N 5/022; G06F 9/453; G06F 40/56

(57) ABSTRACT

Exemplary embodiments of the present disclosure are directed towards a system for explaining actions taken in real-time on event stream, comprising: a computing device comprises a data analyzation and precise decision module configured to take inputs, the data analyzation and precise decision module configured to analyze the inputs and implements decisions on the computing device, the data analyzation and precise decision module also configured to send a written narrative and give an explanation about the plurality of decisions to a user in a natural language; and a database configured to house the most of the information known to the data analyzation and precise decision module, the database comprises an action table to implement any decision being taken in the data analyzation and precise decision module and updates the action table based on the user responds to the data analyzation and precise decision module.

### TECHNICAL FIELD

The disclosed subject matter relates generally to system and computer implemented methods for making precise decisions in real-time using a natural language generation (NLG) module. More particularly, the present disclosure relates to a system and method for analyzing digital data and making precise decisions in real-time, explaining narratives and decisions using the natural language generation (NLG) module.

### BACKGROUND

Business organizations need decisions about strategies repeatedly. A decision is strategic if it defines, maintains, or changes an organization's mission, scope and/or differentiation. To achieve goals, missions and objectives, the organization must constantly make decisions and take actions based on those decisions. In a typical organization, a host of decisions take place at all levels of the organization on the recurring basis. In this digital age, there is a big onus on making data-driven decisions. However, there is a sudden outburst of huge amounts of data from which the decision-makers are expected to base their decisions. This places a huge cognitive load on the decision-makers to go through the huge pile of data, which comes with its share of ineffectual data limiting the speed at which the data can be converted to a business decision. As is the norm, businesses have turned to dashboard tools that help bring all their data in a single place. But this only solves half of their problems.

People still have to sit and go through each dashboard and based on their understanding come up with actions to take. This leaves the decision-making process prone to human error/misjudgment. There are chances of different people looking at the same thing coming to different conclusions. All of this further delays the decision-making process and can lead to significant losses in the long run. Despite efforts to integrate various data sources of business organizations, the decision-makers may not have access to rapid, consistent information about other decisions that have taken place, or that are proposed to take place, within the organization. Also, even if the decision-makers operate based on good data and make good decisions, the objectives of decision-makers in different parts of the organization produce decisions that are inconsistent with achieving the strategic objectives of the enterprise as a whole. The available systems cannot solve the problem by looking at all the data like a human would and come up with actions to take. Also, the existing systems are not providing a reason for what has happened and why was a particular decision necessary. Adding the complexity of writing language for all the different parts of an organization that understand things differently, and a team of people will be required to just make personalized reports which holds these reasons behind the decisions. These reports can only be generated after some time has elapsed after making the decision and cannot help change or help in blocking an action that might not be required, since it is already late.

In the light of the aforementioned discussion, there exists a need for a certain system with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards taking one or more user's actions as inputs which are used in profiling one or more users to help make better and more appropriate decisions for the users, explaining one or more decisions with custom and easy to consume narratives customized for the user in any given situation.

Another objective of the present disclosure is directed towards helping the business organization to understand what is happening through the narratives but also save precious time by already implementing actions that need to be taken to a re-correct course or drive more profits.

Another objective of the present disclosure is directed towards the system collects inputs such as the events or data related to the user captured in some form. The events then help the system in realizing that a change has occurred and helps it decide what will be the appropriate action to be taken in this case to execute the decision being taken.

Another objective of the present disclosure is directed towards the system stores all of the captured information which can range from user actions to the core decision framework models, and can keep learning from a wide variety of sources and also can learn via reinforcement learning by updating itself basis how impactful is the decision taken for each new event.

Another objective of the present disclosure is directed towards the system houses all the domain knowledge by learning in different ways, be it online or through some user actions. The information houses numerous domains and helps make better decisions in a similar situation in various domains.

Another objective of the present disclosure is directed towards the system helps make sense of all the user events and data available throughout the system.

Exemplary embodiments of the system and method for explaining actions taken in real-time on event stream using natural language generation.

According to an exemplary aspect of the present disclosure, the system comprising a data analyzation and precise decision module configured to take a plurality of inputs, the data analyzation and precise decision module configured to analyze the plurality of inputs and implements a plurality of decisions on a computing device, the data analyzation, and precise decision module also configured to send a written narrative and give an explanation about the plurality of decisions to a user in a natural language.

According to an exemplary aspect of the present disclosure, the system comprising a database configured to house the most of the information known to the data analyzation and precise decision module and acts as a memory to store captured information ranges from a plurality of user actions to core decision framework models, the database also configured to keep learning from a plurality of sources and also learn via reinforcement Learning by updating itself basis how impactful the decision has taken for each new event, the database comprises an action table to implement any decision being taken in the data analyzation and precise decision module and updates the action table based on the user responds to the data analyzation and precise decision module.

### BRIEF DESCRIPTION OF THE DRAWINGS

FIG. 1 is a block diagram depicting a schematic representation of a system for explaining actions taken in real-time on event stream using natural language generation, in accordance with one or more exemplary embodiments.

FIG. 2 is a block diagram depicting the data analyzation and precise decision module 104 shown in FIG. 1, in accordance with one or more exemplary embodiments.

FIG. 3 is a flow diagram depicting a method for explaining actions taken in real-time on event stream, in accordance with one or more exemplary embodiments.

FIG. 4 is a flow diagram depicting a method for updating the action table in the database to better suit the user profile, in accordance with one or more exemplary embodiments.

FIG. 5 is a flow diagram depicting a method for keep on updating the actions in the database, in accordance with one or more exemplary embodiments.

FIG. 6 is a flow diagram depicting a method for presenting the output to the user and enabling the user to give feedback, in accordance with one or more exemplary embodiments.

FIGS. 7A and 7B are example screens depicting the main data, in accordance with one or more exemplary embodiments.

FIG. 8A is another example screen depicting the notification of the occurrence of an event after short period of time, in accordance with one or more exemplary embodiments.

FIG. 8B is another example screen depicting the notification of the reoccurrence of the event, in accordance with one or more exemplary embodiments.

FIG. 9 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

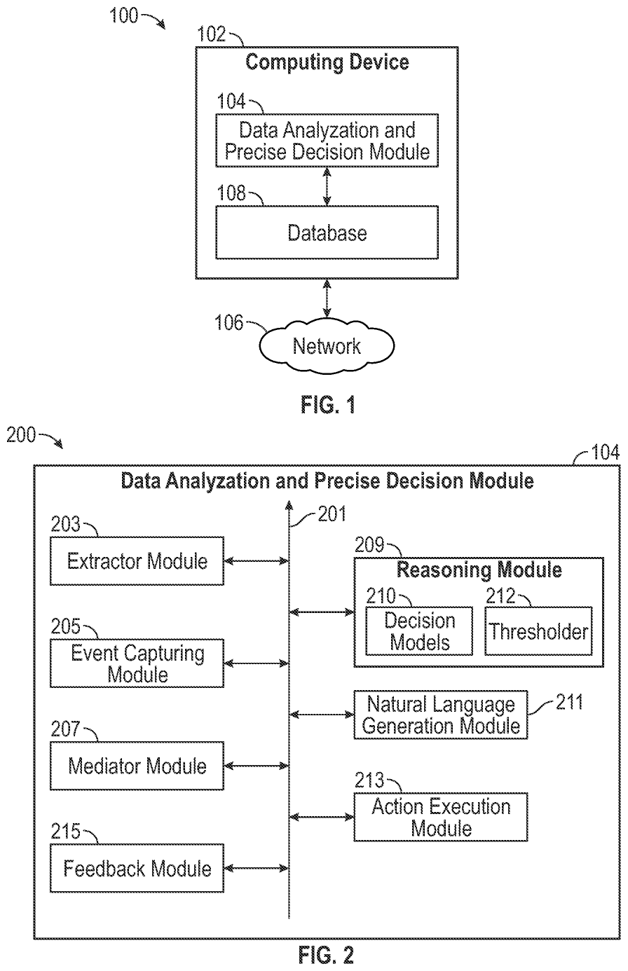

Referring to FIG. 1 is a block diagram 100 depicting a schematic representation of a system for explaining actions taken in real-time on event stream using natural language generation, in accordance with one or more exemplary embodiments. The system 100 includes a computing device 102, a data analyzation and precise decision module 104, and a network 106. The computing device 102 may be connected to the one or more computing devices via the network 106. The network 106 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 106 may be configured to provide access to different types of users. The computing device 102 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The data analyzation and precise decision module 104 is accessed as a mobile application, web application, software that offers the functionality of accessing mobile applications, and viewing/processing of interactive pages.

The data analyzation and precise decision module 104 may be configured to solve the problem by looking at all the data like a human would and come up with actions to take. The actions may be derived based on what decision needs to be taken if certain patterns are found in the data being analyzed. The data analyzation and precise decision module 104 may be configured to analyze the data and reach a conclusion that drives the decision that needs to be taken. Actions are then further taken to implement these decisions, all of which hardly takes any time for the data analyzation and precise decision module 104 to do. The data analyzation and precise decision module 104 may be configured to send a written narrative to a user about the decision has taken and given an explanation on why a certain decision is necessary. The user may include, but not limited to, a company, an organization, a firm, a customer, a person, a consumer, a client, an employee, and so forth. The data analyzation and precise decision module 104 not only helps the user to understand what is happening through the narratives but also save precious time by already implemented actions that need to be taken to the re-correct course or drive more profits.

The data analyzation and precise decision module 104 may be configured to make decisions for the users based on what it sees in data and implement them via some actions. The data analyzation and precise decision module 104 may be configured to take the user's action as one of the inputs which are used in profiling that user to help make better and more appropriate decisions for the user, while also providing helpful and easy to consume narratives customized for the user in any given situation. The other input coming into the data analyzation and precise decision module 104 may be the events or data related to the user captured in some form. The events then help the data analyzation and precise decision module 104 in realizing that a change has occurred and helps it decide what may be the appropriate action to be taken in this case to execute the decision being taken.

Although the computing device 102 is shown in FIG. 1, an embodiment of the system 100 may support any number of computing devices. The computing device 102 may be operated by the user. The computing device 102 supported by the system 100 is realized as a computer-implemented or computer-based device having the hardware or firmware, software, and/or processing logic needed to carry out the computer-implemented methodologies described in more detail herein. The data analyzation and precise decision module 104 may include a database 108. The database 108 may be configured to hold digital data to run the analysis. The digital data may include, but not limited to, business data, learned data, metadata, mining data, user data, and so forth. The database 108 may be the knowledge base database.

The database 108 may be the knowledge base database houses most of the information known to the data analyzation and precise decision module 104. The database 108 may act as a memory to store all of the captured information which ranges from the user actions to the core decision framework models, and may keep learning from a wide variety of sources and also learns via a reinforcement learning technique by updating itself basis how impactful is the decision for each new event. The database 108 may be configured to house all the domain knowledge by learning in different ways, be it online or through some user actions. The information houses numerous domains and helps make better decisions in a similar situation in various domains. The database 108 may include in house analysis framework which includes various models and machine learning techniques, which help make sense of all the user events and data available throughout the system 100.

The computing device 102 includes the data analyzation and precise decision module 104 configured to take inputs, the data analyzation and precise decision module 104 may be configured to analyze the inputs and implements decisions on the computing device 102, the data analyzation and precise decision module 104 also configured to send a written narrative to a user about the decisions and give an explanation on why the certain decision is necessary. The database 108 may be configured to house the most of the information known to the data analyzation and precise decision module 104 and acts as a memory to store captured information ranges from user actions to core decision framework models, the database 108 also configured to keep learning from sources and also learn via reinforcement Learning by updating itself basis how impactful the decision has taken for each new event, the database 108 includes the action table to implement any decision being taken in the data analyzation and precise decision module 104 and updates the action table based on the user responds to the data analyzation and precise decision module 104.

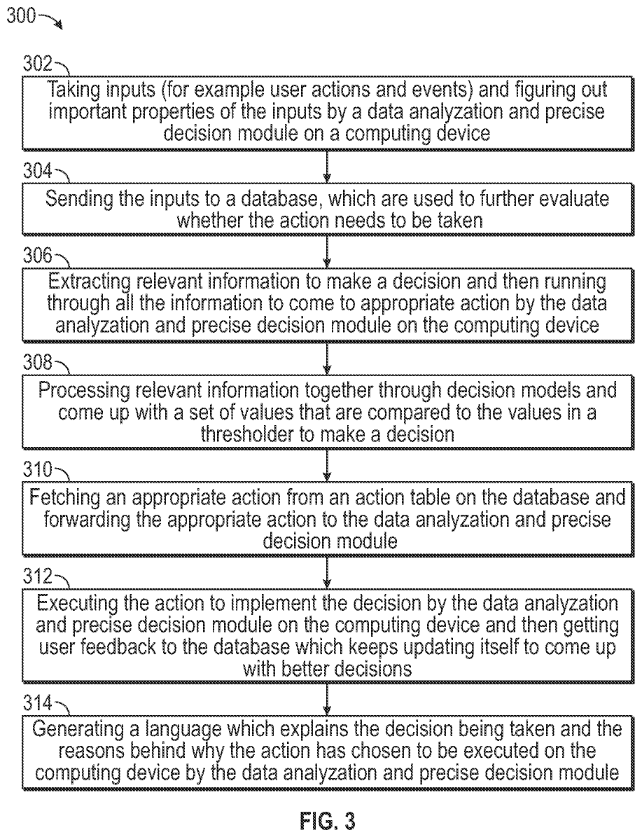

Referring to FIG. 2 is a block diagram 200 depicting the data analyzation and precise decision module 104 shown in FIG. 1, in accordance with one or more exemplary embodiments. The data analyzation and precise decision module 104 includes a bus 201, an extractor module 203, an event capturing module 205, a mediator module 207, a reasoning module 209, a natural language generation module 211, an action execution module 213, and a feedback module 215. The bus 201 may include a path that permits communication among the modules of the data analyzation and precise decision module 104 installed on the computing device 102. The term “module” is used broadly herein and refers generally to a program resident in the memory of the computing device 102.

The store within the knowledge base is the database 108 which saves user and data information extracted by the extractor module 203. The information helps fine-tune the decision and language to suit each user. The last part of the database 108 may be the action table, which is a comprehensive set of all actions that may be taken to implement/execute any decision being taken in the system 100. The set of actions may be tweaked to be exactly what the user needs them to be. Also, these actions may keep on updating the basis of how the user responds to the system action (allowing/blocking).

The extractor module 203 may be configured to take the inputs and churn out important properties of the inputs which is then sends to the database 108 where it is stored for the future. The inputs may include, but not limited to, user actions and events. The event capturing module 205 may be configured to take the event information (which may also be any user data/information) and figure out important properties of event information which are then used to further evaluate whether the action needs to be taken. The reasoning module 209 may include a set of algorithms that decide what all information needs to be considered to make a decision and then runs through all the information to come to an appropriate action that may be taken.

The reasoning module 209 may include decision models 210, and a thresholder 212. The decision models 210 may be algorithms and structures that help the reasoning reach the final decision and decide what action is to be taken. The thresholder 212 may be configured to hold a wide variety of points which vary for each domain as well as each user, which help decide/evaluate what to make of the event information just entered in the data analyzation and precise decision module 104, and what type of decision needs to be taken. The mediator module 207 may be configured to connect the inputs to other components by fetching and transferring all the needed data/information. The action execution module 213 may be responsible for final executing the action to implement the decision and then to get the user feedback from the feedback module 215 to the database 108 which may keep updating itself to come with better decisions. The natural language generation module 211 may be configured to use a combination of methods to explain the decision in a natural language that being taken and the reasons behind why the action is chosen to be executed. The natural language generation module 211 may be configured to explain the decisions to the user in the natural language.

The data analyzation and precise decision module 104 may be configured with all the information for different domains as well as all the algorithms and decisions needed to make important decisions. When the user connects any source to the data analyzation and precise decision module 104, the data analyzation and precise decision module 104 starts capturing events which it may deem important or which the user asks to be monitored specifically. All such events may be captured and processed through the data analyzation and precise decision module 104, while also updating the data analyzation and precise decision module 104 itself for domain and user information. As an example take a stock trading use case in which the system already has access to live stocks data through an API, and also has the user's personal portfolio information and its current value. To drive the most profit the user may need to do an instant buy/sell transaction due to some event information that just broke out.

The data analyzation and precise decision module 104 may be configured to capture all information, may be via news sites or some other real time sources and then the event capturing module 205 may get important pieces of information from these sources related to the user, with the help of the information in the user Meta store and pass it to reasoning module 209 for further action. The reasoning module 209 with the help of the database 108 may process all relevant information together through its decision models and come up with a set of values that may be compared to the values in the thresholder 212 to decide on whether to take an action or not. For example, the data analyzation and precise decision module 104 captures the quarterly revenue figures and check all historical domain knowledge to conclude whether the numbers are good or not. A decision may be made basis all this in the reasoning module 209 and the decision may be taken which may, in this case, be to sell the stock as quickly as possible to avoid any losses predicted.

As the decision may be made the reasoning module 209 may again rely on the database 108 to fetch the appropriate action to be taken from the action table, which may be forwarded to the action execution module 213 to execute, which in this case is to place a sell order. Also, a similar output may be pushed to the natural language generation module 211, which may take all parameters into account and produce the language to explain the decision and action being taken and also, produce reasons for it which may help the user to understand the need and logic behind the decisions. The output may be presented to the user immediately, which if the user finds unsuitable, may disagree with the decision and block it which may act as a feedback loop to the data analyzation and precise decision module 104 to update the user profile information and action table to better suit the user in a similar situation in the future. While the entire process keeps repeating the database 108 keeps on self-learning via various resources and for multiple domains which enables the data analyzation and precise decision module 104 to make the most precise decision at any given time.

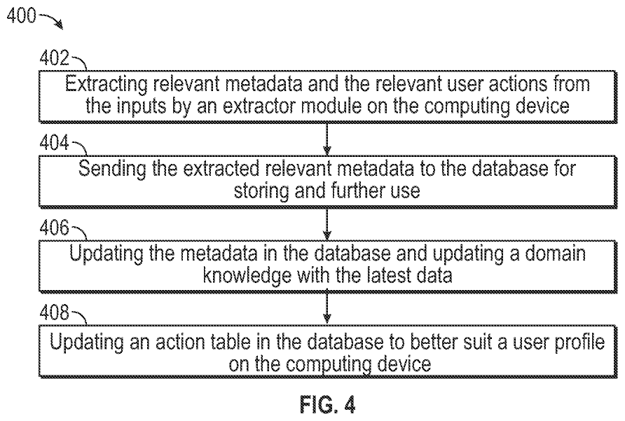

Referring to FIG. 3 is a flow diagram 300 depicting a method for explaining actions taken in real-time on event stream, in accordance with one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, the data analyzation and precise decision module take inputs (for example user actions and events) and figures out important properties of the inputs on the computing device. Thereafter, at step 304, the data analyzation and precise decision module send the inputs to the database, which are used to further evaluate whether the action needs to be taken. Thereafter, at step 306, the data analyzation and precise decision module extracts relevant information to make then the decision and then runs through all the information to come to the appropriate action on the computing device. Thereafter, at step 308, the relevant information processes together through the decision models and come up with a set of values that are compared to the values in the thresholder to make the decision. Thereafter, at step 310, the appropriate action fetches from the action table on the database and forwards the appropriate action to the data analyzation and precise decision module. Thereafter, at step 312, the data analyzation and precise decision module execute the action to implement the decision on the computing device and then get the user feedback to the database which keeps updating itself to come up with better decisions. Thereafter, at step 314, the data analyzation and precise decision module generate the language which explains the decision being taken and the reasons behind why the action has chosen to be executed on the computing device.

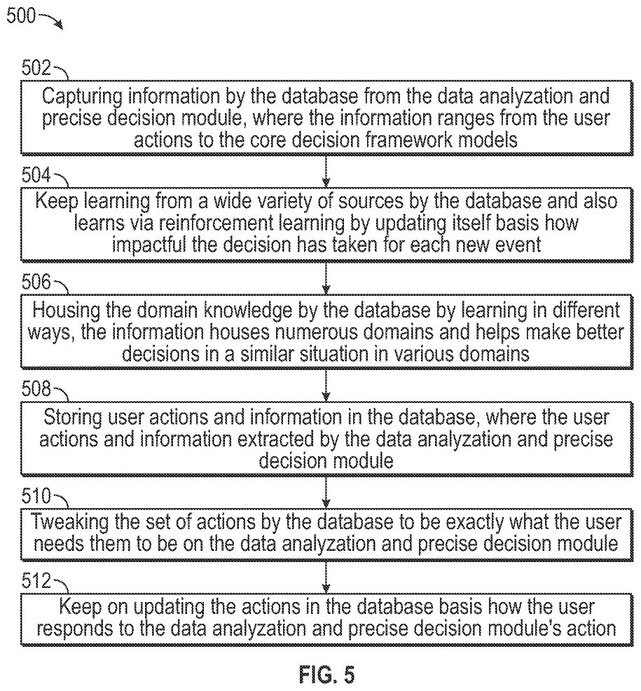

Referring to FIG. 4 is a flow diagram 400 depicting a method for updating the action table in the database to better suit the user profile, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, the extractor module extracts the relevant metadata and relevant user actions from the inputs on the computing device. Thereafter, at step 404, the extractor module sends the extracted relevant metadata to the database for storing and further use. Thereafter, at step 406, the database updates the metadata and the domain knowledge with the latest data. Thereafter, at step 408, the database updates the action table to better suit the user profile on the computing device.

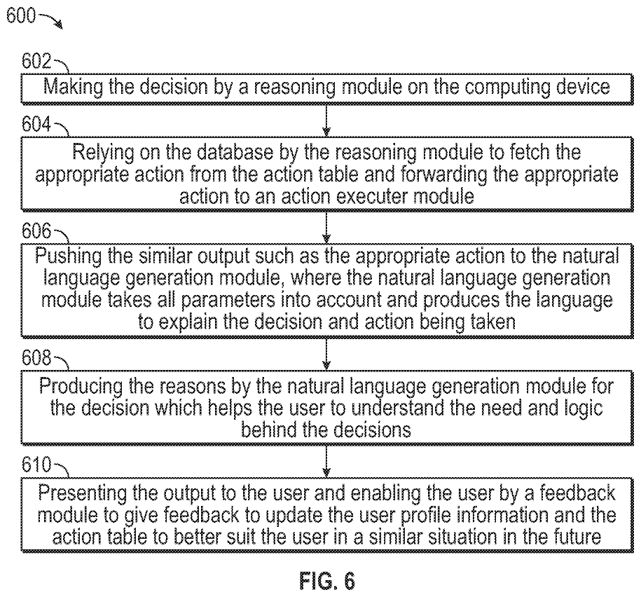

Referring to FIG. 5 is a flow diagram 500 depicting a method for keep on updating the actions in the database, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The database captures the information from the data analyzation and precise decision module, where the information ranges from the user actions to the core decision framework models, at step 502. Thereafter, 504, the database learns from the wide variety of sources and also learns via Reinforcement Learning by updating itself basis how impactful the decision has taken for each new event. Thereafter, at step 506, the database houses the domain knowledge by learning in different ways, the information houses numerous domains and helps make better decisions in a similar situation in various domains. Thereafter, at step 508, the database stores the user actions and information, where the user actions and information extracted by the data analyzation and precise decision module. Thereafter, at step 510, the database tweaks the set of actions to be exactly what the user needs them to be on the data analyzation and precise decision module. Thereafter, at step 512, the database keeps on updating the actions basis how the user responds to the data analyzation and precise decision module's action.

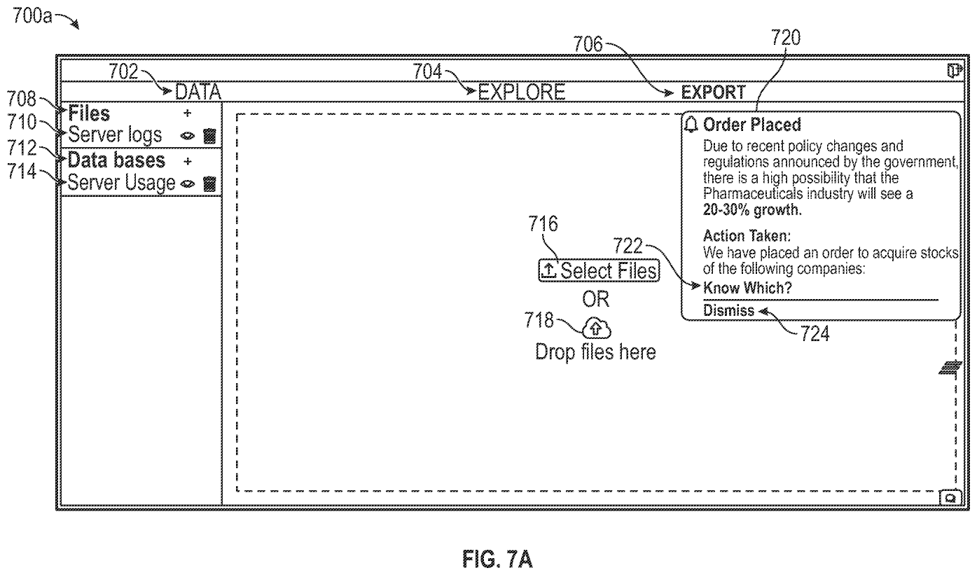

Referring to FIG. 6 is a flow diagram 600 depicting a method for presenting the output to the user and enabling the user to give a feedback, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The reasoning module makes the decision on the computing device at step 602. Thereafter, at step 604, the reasoning module relays on the database to fetch the appropriate action from the action table and forwards the appropriate action to the action executer module. Thereafter, at step 606, the reasoning module pushes a similar output such as the appropriate action to the natural language generation module, where the natural language generation module takes all parameters into account and produces the language to explain the decision and action being taken. Thereafter, at step 608, the natural language generation module produces the reason for the decision which helps the user to understand the need and logic behind the decisions. Thereafter, at step 610, the natural language generation module presents the output to the user and the feedback module enables the user to give the feedback to update the user profile information and the action table to better suit the user in a similar situation in the future.

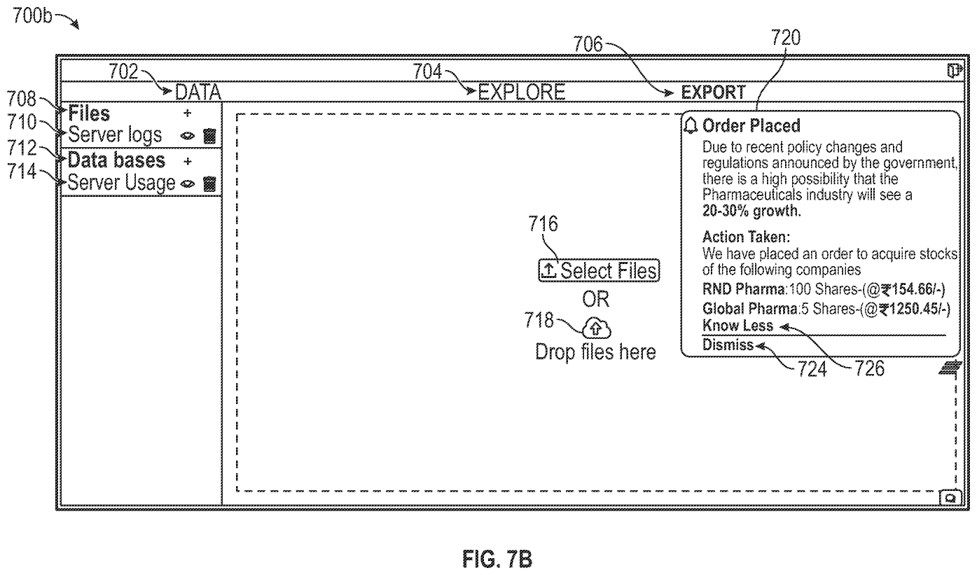

Referring to FIGS. 7A, and 7B are example screens 700a and 700b depicting the main data, in accordance with one or more exemplary embodiments. The screen 700a and 700b depicts a data option 702, an explore option 704, an export option 706, files option 708, server logs option 710, databases option 712, a server usage option 714, select files option 716, drop files option 718 and a notification screen 720. On selecting the data option 702 the screen 700a and 700b depicts a search log option, a sales record option, and a store option. On selecting the explore option 704, the screen 700a and 700b depicts a first summary option and a second summary option. On selecting the export option 706, the screen 700a and 700b displays the pie chart visualization screen separately on the computing device 102. The main data screens 700a and 700b may display the notification screen 720. The notification screen 720 includes know which option 722, and a dismiss option 724. On selecting know which option 722, the notification screen 720 on the screen 700b displays the exact details of the shares. For example, the exact details of the shares may include RND pharma share, or Global pharma shares and the like. The notification screen 720 on the screen 700b displays know less option 726. On selecting know less option 726, the screen 700b may not display the exact details of the shares on the computing device 102. On selecting the dismiss option 724, the notification screen 720 may be dismissed from the screens 700a and 700b. The files option 708 and the databases option 712 may be configured to keep the database 108 (As shown in FIG. 1) update with the essential data sources related to the user. The server logs option 710 and the server usage option 714 may be configured to keep the track of server usage. The server logs option 710 and the server usage options 714 are may be the examples of data sources being used to come up with the decisions. The select files option 716 may allow the user to upload the required file. The drop files option 718 may be configured to drop down the files for uploading.

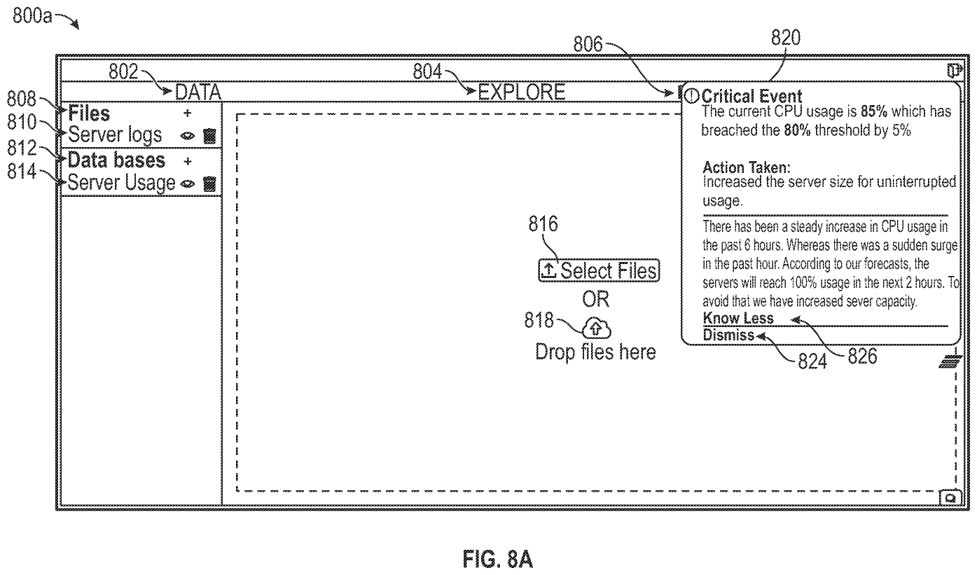

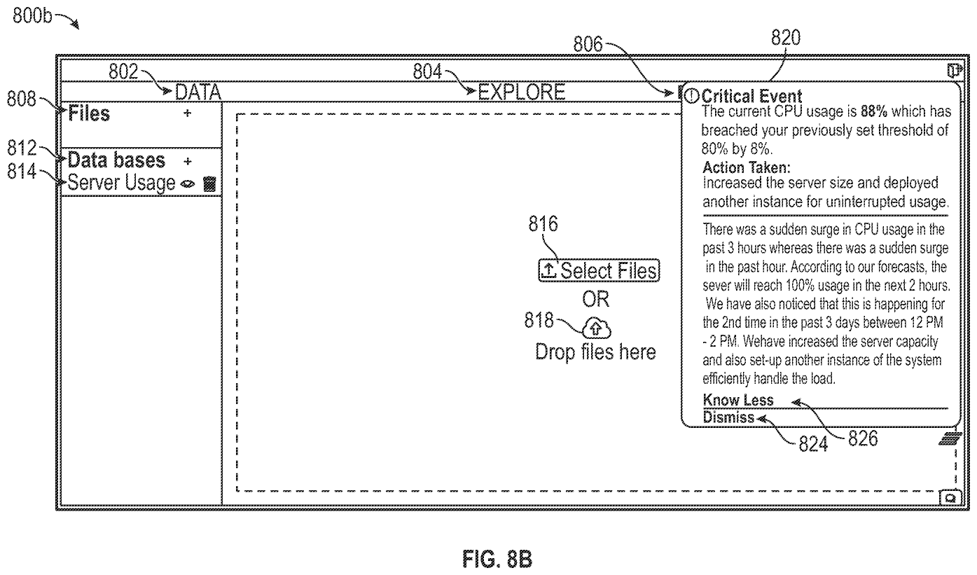

Referring to FIG. 8A is another example screen 800a depicting notification of the occurrence of an event after short period of time, in accordance with one or more exemplary embodiments. The screen 800a depicts a data option 802, an explore option 804, an export option 806, files option 808, server logs option 810, databases option 812, a server usage option 814, select files option 816, drop files option 818 and a notification screen 820. The server usage option 814 may be configured to display the usage of the server. The select files option 816 may allow the user to upload the required file. The notification screen 820 depicts the critical event and action taken. For example, the notification screen 820 notifies the current CPU usage is 85% which has breached the 80% threshold by 5%. The notification screen 820 may also notifies the action taken. (For example, displaying the increased server size for uninterrupted usage. There has been a steady increase in CPU usage in the past six hours. Whereas there was a sudden surge in the past hour. According to our forecasts, the server will reach 100% usage in the next 2 hours. To avoid that we increased server capacity.) On selecting the data option 802 the screen 800 depicts a search log option, a sales record option, and a store option. On selecting explore option 804, the screen 800 depicts a first summary option and a second summary option. On selecting the export option 806, the screen 800 displays the pie chart visualization screen separately on the computing device 102 (As shown in FIG. 1). On selecting know which option 822, the notification screen 820 on the screen 800 displays the critical event on the computing device 102. On selecting know less option 826, the screen 800 may not display the critical event on the computing device 102 (As shown in FIG. 1). On selecting the dismiss option 824, the notification screen 820 may be dismissed from the screen 800.

Referring to FIG. 8B is another example screen 800b depicting the notification of the reoccurrence of the event, in accordance with one or more exemplary embodiments. The screen 800b may depict the notification screen 820. The notification screen 820 may be configured to notify the user in the reoccurrence of the event. The notification screen 820 may display the critical event and the action taken. For example, the critical event may display the current CPU usage is 88% which has breached your previously set threshold of 80% by 8%. The action taken may display the increased the server size and deployed another instance for uninterrupted usage. There was a sudden surge in CPU usage in the past 3 hours, whereas there was a sudden surge in the past hour. According to our forecast, the server will reach 100% usage in next 2 hours. We also noticed that this is happening for the second time in the past three days between 12 pm-2 pm. We have increased the server capacity and also set-up another instance of the system to efficiently handle the load.

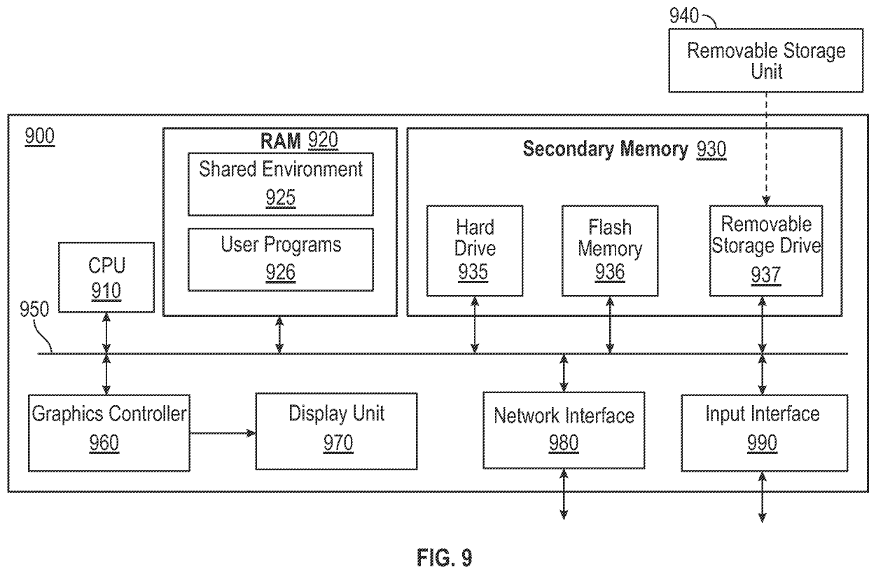

Referring to FIG. 9 is a block diagram 900 illustrating the details of a digital processing system 900 in which various aspects of the present disclosure are operative by execution of appropriate software instructions. The Digital processing system 900 may correspond to the computing device 102 (or any other system in which the various features disclosed above can be implemented).

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 830 using communication path 950. RAM 920 is shown currently containing software instructions, such as those used in threads and stacks, constituting shared environment 925 and/or user programs 926. Shared environment 925 includes operating systems, device drivers, virtual machines, etc., which provide a (common) run time environment for execution of user programs 926.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with other systems (such as those shown in FIG. 1) connected to the network 106.

Secondary memory 930 may contain hard drive 935, flash memory 936, and removable storage drive 937. Secondary memory 930 may store the data software instructions (e.g., for performing the actions noted above with respect to the Figures), which enable digital processing system 900 to provide several features in accordance with the present disclosure.

Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EEPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 950. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

We claim:

1. A system for explaining actions taken in real-time on event stream, comprising:
a computing device comprising a data analyzation and precise decision module configured to take a plurality of inputs, whereby the data analyzation and precise decision module configured to analyze the plurality of inputs and implements a plurality of decisions on the computing device, the data analyzation and precise decision module also configured to send a written narrative and give an explanation about the plurality of decisions to a user in a natural language; and
a database configured to house the most of the information known to the data analyzation and precise decision module and acts as a memory to store captured information ranges from a plurality of user actions to core decision framework models, the database also configured to keep learning from a plurality of sources and also learn via a reinforcement Learning technique by updating itself basis how impactful the decision has taken for each event, the database comprising an action table to implement any decision being taken in the data analyzation and precise decision module and updates the action table based on the user responds to the data analyzation and precise decision module.

2. The system of claim 1, wherein the database is configured to house a domain knowledge by learning in different ways and information houses a plurality of domains and helps make better decisions in a similar situation in the plurality of domains.

3. The system of claim 1, wherein the data analyzation and precise decision module comprises an extractor module configured to take the plurality of inputs and churns out properties of the plurality of inputs and sends the plurality of inputs to the database.

4. The system of claim 1, wherein the data analyzation and precise decision module comprising an event capturing module configured to take event information and figure out the properties of the event information on the computing device.

5. The system of claim 1, wherein the data analyzation and precise decision module comprising a reasoning module configured decide the information to make the plurality of decisions and then runs through all information to come to an appropriate action that has taken on the computing device.

6. The system of claim 5, wherein the reasoning module comprising decision models configured to help the reasoning reach the plurality of decisions and decides what action is to be taken.

7. The system of claim 5, wherein the reasoning module comprising a thresholder configured to hold a wide variety of points which vary for each domain as well as each user, which help decide/evaluate what to make of the event information just entered in the data analyzation and precise decision module.

8. The system of claim 1, wherein the data analyzation and precise decision module comprising a mediator module configured to connect the plurality of inputs to components by fetching and transfers needed data.

9. The system of claim 1, wherein the data analyzation and precise decision module comprising an action execution module configured to execute the action to implement the decision and then to get the user feedback from a feedback module to the database which keeps updating itself to come with better decisions.

10. The system of claim 1, wherein the data analyzation and precise decision module comprising a natural language generation module configured to use a combination of methods to generate a language that explains the decision being taken and the reasons behind why the action is chosen to be executed.

11. The system of claim 1, wherein the data analyzation and precise decision module comprising a natural language generation module configured to use a combination of methods to explain the plurality of decisions in the natural language that being taken and the reasons behind why the action is chosen to be executed.

12. The system of claim 1, wherein the data analyzation and precise decision module comprising an action execution module configured to execute actions and the action execution module pushes the executed actions to the natural language generation module.

13. The system of claim 11, wherein the natural language generation module is configured to take all parameters into account and produce the natural language to explain the decision and action being taken on the computing device.

14. A method for explaining actions taken in real-time on event stream, comprising:
taking a plurality of inputs and figuring out properties of the plurality of inputs by a data analyzation and precise decision module on a computing device, whereby the data analyzation and precise decision module sends the plurality of inputs to a database and analyzes the plurality of inputs and implements a plurality of decisions on the computing device;
extracting relevant information to make a decision and then running through all the information to come to appropriate action by the data analyzation and precise decision module on the computing device, the data analyzation and precise decision module also configured to send a written narrative to a user about the plurality of decisions and give an explanation on why the certain decision is necessary;
processing relevant information together through decision models and come up with a set of values that are compared to the values in a thresholder to make a decision and fetching an appropriate action from an action table on the database and forwarding the appropriate action to the data analyzation and precise decision module;
executing the action to implement the decision by the data analyzation and precise decision module on the computing device and then getting user feedback to the database which keeps updating itself to come up with better decisions; and
generating a language that explains the decision being taken and the reasons behind why the action has chosen to be executed on the computing device by the data analyzation and precise decision module.

15. A computer program product comprising a non-transitory computer-readable medium having a computer-readable program code embodied therein to be executed by one or more processors, said program code including instructions to:
take a plurality of inputs and figuring out properties of the plurality of inputs by a data analyzation and precise decision module on a computing device, whereby the data analyzation and precise decision module sends the plurality of inputs to a database and analyzes the plurality of inputs and implements a plurality of decisions on the computing device;
extract relevant information to make a decision and then running through all the information to come to appropriate action by the data analyzation and precise decision module on the computing device, the data analyzation and precise decision module also configured to send a written narrative to a user about the plurality of decisions and give an explanation on why the certain decision is necessary;
process relevant information together through decision models and come up with a set of values that are compared to the values in a thresholder to make a decision and fetching an appropriate action from an action table on the database and forwarding the appropriate action to the data analyzation and precise decision module;
execute the action to implement the decision by the data analyzation and precise decision module on the computing device and then getting user feedback to the database which keeps updating itself to come up with better decisions; and
generate a language that explains the decision being taken and the reasons behind why the action has chosen to be executed on the computing device by the data analyzation and precise decision module.
